(19) United States
(12) Patent Application Publication
(10) Pub. No.: US 2024/0393497 A1
(43) Pub. Date: Nov. 28, 2024

(54) TEST SYSTEM FOR DOWNHOLE EQUIPMENT

(71) Applicant: Welltec Manufacturing Center Completions ApS, Esbjerg N (DK)

(72) Inventor: Kasper Holst FORNITZ, Esbjerg N (DK)

(21) Appl. No.: 18/674,370

(22) Filed: May 24, 2024

(30) Foreign Application Priority Data
May 25, 2023 (EP) 23175306.2

(51) Int. Cl. G01V 99/00

(52) U.S. Cl. CPC G01V 99/00

(57) ABSTRACT

A test system comprising a first CO₂ vessel having a first predefined volume configured to hold and/or receive a first predefined amount of CO₂, having a first CO₂ output, a second CO₂ vessel having a second predefined holding volume configured to hold and/or receive a second predefined amount of CO₂ having a second CO₂ input, a test section having a third CO₂ input in fluid communication with the first CO₂ output and a third CO₂ output in fluid communication with the second CO₂ input, where the test section is configured to hold a first sample, a first valve arranged between the first CO₂ output and the third CO₂ input, and a second valve arranged between the third output and the second CO₂ input.

The present invention relates to a test system comprising a first CO₂ vessel having a first predefined volume configured to hold and/or receive a first predefined amount of CO₂, having a first CO₂ output, where the test section is configured to hold a first sample, a first valve is arranged between the first CO₂ output and the third CO₂ input, and a second valve is arranged between the third output and the second CO₂ input.

There are a number of different ways of attempting to find ways of providing storage for CO₂ that has been captured from the atmosphere or from carbon emissions in order to reduce the content of CO₂ in the atmosphere.

A number of ways have been developed where CO₂ may be captured from the atmosphere or from emissions having a CO₂ content, where the CO₂ has been captured in its gaseous phase and has been collected in tanks or other types of storage vessels. However, methods are continuously being developed attempting to store the captured CO₂ responsibly, and thereby reducing the possibility of the CO₂ being re-released into the atmosphere.

One way of doing so is to pump the CO₂ into oil wells, or into boreholes of wellsites, after the wells have been depleted, and the boreholes are intended to be abandoned. A number of studies have been performed where the corrosion effect of CO₂ has been tested on the structures of boreholes, such as the metal casings, etc., in order to ensure that the CO₂ does not cause excessive corrosion on the structure of the borehole and to ensure that the CO₂ does not reduce the lifespan of the abandoned borehole.

However, as the CO₂ is to be pumped into existing structures that have been utilised for different purposes in the past, the existing structures often have numerous parts of equipment that have been relevant for e.g. the production of oil in the borehole. Such parts may be valves or other parts arranged inside the inner diameter of a borehole casing.

Alternatively, existing wells that may be utilised for CO₂ storage may be retrofitted to serve the purpose of CO₂ storage for Carbon Capture. This means that new completion equipment and downhole parts/equipment may be installed in the well, where the new equipment may have different or smaller inner diameters, which can cause pressure losses across the newly installed completion equipment and/or downhole parts or downhole equipment.

The behaviour of valves and downhole equipment is known in the oil production industry, but as CO₂ has a completely different behaviour than oil, there is a need to understand how the downhole equipment will affect a stream of CO₂ being pumped into the borehole.

In accordance with the invention, there is provided a test system comprising: a first CO₂ vessel having a first predefined volume configured to hold and/or receive a first predefined amount of CO₂, having a first CO₂ output, a second CO₂ vessel having a second predefined holding volume configured to hold and/or receive a second predefined amount of CO₂ having a second CO₂ input, a test section having a third CO₂ input in fluid communication with the first CO₂ output and a third CO₂ output in fluid communication with the second CO₂ input, where the test section is configured to hold a first sample, a first valve is arranged between the first CO₂ output and the third CO₂ input, and a second valve is arranged between the third CO₂ output and the second CO₂ input.

The test system may be configured for testing at least a first effect of a CO₂ stream passing a downhole part.

The test system is configured to provide a flow of CO₂ past a test section, where the test section may be configured to hold a downhole part or downhole equipment, and where the flow of CO₂ may be provided in a controlled manner past the test section at a predefined flowrate or at a predefined pressure. The test system has a first CO₂ vessel that may be configured to hold a predefined amount of CO₂ inside the first CO₂ vessel, and where the first CO₂ vessel may be filled with CO₂ prior to an execution of a test. The first valve may be configured to selectively prevent the CO₂ from being released from the first CO₂ vessel prior to testing, and during testing the first valve may be opened in order to allow a stream of CO₂ to exit the first output of the first CO₂ vessel.

The test section may be in fluid communication with the first CO₂ vessel, where the first valve may open and close the fluid communication between the first CO₂ vessel and the test section. When the CO₂ flow has been initiated in the test system, the CO₂ will flow through the test section, and the CO₂ will exit the third output of the test section, which is in fluid communication with the second CO₂ vessel. The CO₂ will flow from the test section and into the second input of the second CO₂ vessel, where the spent CO₂ that has passed through the test section will be collected by the second CO₂ vessel, and where the spent CO₂ will provide a second predefined amount of CO₂ inside the second CO₂ vessel.

The test system may be a closed system, so that the CO₂ that exits the first CO₂ vessel is passed through closed fluid communication channels that are eventually connected with the second CO₂ vessel, so that the majority of the CO₂ released by the first CO₂ vessel is collected by the second CO₂ vessel, and the second valve may be closed to ensure that the CO₂ does not escape from the second CO₂ vessel after the performance of the test.

The test system may thereby be utilised to provide a CO₂ flow past a downhole part which is arranged inside the test section, where the effect of the CO₂ flow past the downhole part may be monitored and observed in order to understand how CO₂ flow inside a borehole will react when the CO₂ comes into contact with a downhole part.

The test system may be configured to operate so that the pressure of the CO₂ or the flowrate of the CO₂ may be controlled through the test section, where the test system may be configured to perform tests at a specific flowrate of CO₂ through the test section 7, and where the effect of the specific flowrate when passing specific downhole equipment may be observed, or where the tests are performed at a predefined pressure upstream of the test section 7 to observe the effect of the downhole equipment on the pressure of the CO₂.

The fluid communication between parts of the test system may be provided via fluid conduits, pipes, fluid lines, pipelines, channels or other types of fluid communication means that ensure a fluid communication pathway from one part of the test system to another part of the test system.

Within the understanding of the present disclosure, the term “downhole part” or “downhole equipment” may mean any part of a cased borehole that may be present inside the inner diameter of a cased borehole, or inside the inner diameter of the casing. The downhole parts or the downhole equipment may be valves, packers, centralizers, subs, or other types of equipment or parts that are inside a casing.

In one exemplary embodiment, the test system comprises at least one first sensor chosen from a list of a first pressure sensor, a first temperature sensor and a first flow sensor, where the sensor is positioned in fluid communication with the first CO₂ output, and optionally with the third CO₂ input. The sensor may be utilised to provide a first sensor output relating to the condition of the CO₂ in a particular position after the CO₂ has left the first CO₂ output. The first sensor output may be utilised to observe a certain property or condition of the CO₂ before it enters the test section in order to establish a baseline of the CO₂ prior to the CO₂ coming into contact with the downhole equipment that is arranged in the test section.

In one exemplary embodiment, the test system comprises at least one second sensor chosen from a list of a second pressure sensor, a second temperature sensor or a second flow sensor, where the sensor is positioned in fluid communication with the second CO₂ input, and optionally with the third CO₂ output. The second sensor may be utilised to provide a second sensor output relating to the condition of the CO₂ in a particular position after the CO₂ has come into contact with the downhole equipment, i.e. after the CO₂ has left the third CO₂ output. Thus, the second sensor output may be utilised to observe a certain property or condition of the CO₂ after it has flowed through the test section.

Thus, when a first and a second sensor are used, the first sensor output and the second sensor output may be compared to each other to ascertain whether there is any difference between the first sensor output and the second sensor output. As an example, should the first sensor and the second sensor be in the form of pressure sensors, it may be possible to see whether there is a pressure difference in the CO₂ prior to the test section and after the test section, where any pressure difference may indicate the effect of the downhole equipment on the CO₂ flow. Similarly, if the first sensor and the second sensor are flow sensors, the first sensor output and the second sensor output may be compared to each other, and where any difference in flow may be caused by the downhole equipment. Similarly, if the first sensor and the second sensor are temperature sensors, the first sensor output and the second sensor output may be compared to each other, and where any difference in temperature may be caused by the downhole equipment.

Alternatively, other types of sensors may be utilised, such as optical sensors, image sensors or any other sensor that the person skilled in the art would recognise to be useful to obtain a property of the flow of CO₂.

Within the context of the present disclosure, the term “hold” in relation to the CO₂ vessels means that the CO₂ vessel is configured to store a predefined amount of CO₂ in a predefined time period. The storage of the predefined amount of CO₂ may be temporary, where the CO₂ level of the vessel may increase while the vessel is being used to receive the CO₂, and where vessel is configured to release the CO₂ when the CO₂ reaches a predetermined level, or where the vessel is configured to release the CO₂ when a test is to be performed.

In one exemplary embodiment, the test system comprises a third valve arranged between the second CO₂ input and the third CO₂ output and controlled by a second pressure sensor. The second pressure sensor may be in fluid communication with the second fluid output. Thus, the pressure sensor and the valve may be utilised for a feedback loop, where the second pressure sensor output may be utilised to control the third valve. The third valve may be utilised to regulate the flow of CO₂ after the test section, e.g. where there is a need for backpressure downstream of the test section if such a test is required as part of a testing scope.

In one exemplary embodiment, the test system comprises a recirculation loop providing fluid communication between a first CO₂ input of the first CO₂ vessel and a second CO₂ output of the second CO₂ vessel. The provision of a recirculation loop allows the transfer of CO₂ from the second CO₂ vessel to the first CO₂ vessel or vice versa, should it be required to run the test procedure with the CO₂ in the first CO₂ vessel. Thus, when the CO₂ has been captured in the second vessel after testing has been performed, the CO₂ may be recirculated back into the first CO₂ vessel in order to prepare the first CO₂ vessel for a subsequent testing procedure. Thus, the recirculation loop allows the CO₂ to flow in one direction in the test system, where the CO₂ is recirculated towards first CO₂ vessel and is prepared for a subsequent testing.

Alternatively, after testing has been performed, and the CO₂ is present in the second CO₂ vessel, the CO₂ may be transferred using fluid communication in the opposite direction of the testing, i.e. where the CO₂ flows from the second CO₂ input to the third CO₂ output into the testing section, out of the testing section via the third CO₂ input and into the first CO₂ output of the first CO₂ vessel.

Yet further, when the CO₂ is held in the second CO₂ vessel after a testing procedure, the system may be inverted, so that the second CO₂ vessel becomes the first CO₂ vessel, and testing may be performed in an inverse direction to the first testing procedure, where the CO₂ flows from the second CO₂ vessel to the first CO₂ vessel, and where the second CO₂ vessel is thereby seen as the first CO₂ vessel, and the first CO₂ vessel is seen as the second CO₂ vessel.

In one exemplary embodiment, the third output of the test section is in selective fluid communication with the first CO₂ input of the first CO₂ vessel and/or the second CO₂ input of the second CO₂ vessel. This means that the first CO₂ vessel and the second CO₂ vessel may be connected in parallel with the test section, and the third input of the test section may be in selective fluid communication with the first CO₂ output and the second CO₂ output. The test system may be a recirculation loop, where the first CO₂ output of the first CO₂ vessel may be in fluid communication with the third CO₂ input of the test section, and the third CO₂ output of the test section is in fluid communication with the second CO₂ input of the second CO₂ vessel. In this situation, the fluid communication between the first CO₂ input of the first CO₂ vessel and the third CO₂ output of the test section may be closed, and the fluid communication between the second CO₂ output of the second CO₂ vessel and the third CO₂ input of the test section may be closed. Thus, the recirculation process introduces the CO₂ into the second CO₂ vessel to hold it there. When the next testing is to occur, the fluid communication between the first CO₂ input of the first CO₂ vessel and the third CO₂ output of the test section may be open, and the fluid communication between the second CO₂ output of the second CO₂ vessel and the third CO₂ input of the test section may be open, while the fluid communication between first CO₂ output of the first CO₂ vessel and the third CO₂ input of the test section may be closed, and the fluid communication between the third CO₂ output of the test section with the second CO₂ input of the second CO₂ vessel is closed, allowing the second CO₂ vessel to release CO₂ and the first CO₂ vessel to receive the CO₂ after it has passed through the test section.

In one exemplary embodiment, the test system comprises a heat exchanger arranged between the first CO₂ output and the third CO₂ input. The heat exchanger may be used to change the heat of the CO₂ in order to alter the pressure inside the test system, or in order to change the state of the CO₂ inside the test system. The CO₂ may be in liquid form, gas form, supercritical form or solid form during the performance of the testing, and the heat exchanger may be utilised to phase change the CO₂ prior to it entering the test section. The operation of the heat exchanger may be controlled via a feedback loop that may be connected to a first temperature sensor arranged between the first CO₂ output and the third CO₂ input. The heat exchanger may be configured to increase or decrease the temperature of the CO₂ that exits the first CO₂ vessel via the first CO₂ output.

In one exemplary embodiment, the test system comprises a regulator valve positioned between the first CO₂ output and the third CO₂ input. The regulator valve may be configured to control the flowrate and/or pressure through the test block by being arranged downstream of the first CO₂ vessel, and the regulator valve may be adapted to control the flow of CO₂ out of the first CO₂ vessel. Thus, when the first CO₂ vessel holds a predefined amount of CO₂, it may be assumed that the CO₂ is held in the vessel at a first pressure. The regulator valve may open up for fluid communication between the first CO₂ vessel and the test section, and the regulator valve can/may control how much CO₂ is let out of the CO₂ tank, and at what pressure and/or at what flowrate. The pressure may be defined as the effective pressure inside the test section, and the flowrate may be the flowrate of CO₂ that enters the test section.

In one exemplary embodiment, the first CO₂ vessel is configured to have a first pressure, and the second CO₂ vessel is configured to have a second pressure, where the first pressure is greater than the second pressure, or the second pressure is greater than the first pressure. Thus, the pressure difference may be capable of moving the CO₂ from one CO₂ vessel to another CO₂ vessel, as the CO₂ flows from a high-pressure part of the test system to a low-pressure part of the test system.

In one exemplary embodiment, the first CO₂ vessel and/or the second CO₂ vessel comprise(s) a plurality of vessel sections, each having a first predefined volume, where the plurality of vessel sections define the first predefined CO₂ amount and/or the second predefined CO₂ amount. Thus, the first CO₂ vessel and/or the second CO₂ vessel may comprise a plurality of vessel sections, where the predefined number of vessel sections are capable of holding the predefined amount of CO₂ that is intended to be held in the vessel sections. The vessel section may be in the form of e.g. a closed cylinder, where the cylinder has a vessel input and a vessel output.

In one exemplary embodiment, each vessel section comprises a vessel section input and a vessel section output, where the vessel section inputs are in fluid communication with the first CO₂ input and/or the second CO₂ input, and where the vessel section outputs are in fluid communication with the first CO₂ output and/or the second CO₂ output. Thus, each vessel section can operate as an isolated part of the CO₂ vessel. The vessel inputs and vessel outputs may be collected to the first CO₂ input or the second CO₂ input and to the first CO₂ output or the second CO₂ output. Consequently, each vessel section in the first CO₂ vessel or the second CO₂ vessel may be in parallel connection with the vessel CO₂ input and/or the vessel CO₂ output.

In one exemplary embodiment, each vessel section comprises a piston, where one side of the piston is configured to hold an incompressible fluid, and the opposing side of the piston is configured to hold CO₂. The incompressible fluid may be pumped into one side of the piston, thereby causing the piston to move in a direction away from the incompressible fluid, and the piston may therefore be configured to push the CO₂ out of the vessel section. Thus, the movement of the piston reduces the volume of the vessel section on one side of the piston, while it increases the volume of the vessel section on the opposite side of the piston.

In one exemplary embodiment, the first output has a first internal diameter, and the test section has a third internal diameter, where the first internal diameter is larger than or equal to the third internal diameter. The internal diameter of the first output may affect the magnitude and flow of the CO₂ from the first CO₂ vessel and towards the test section. By making sure that the third internal diameter of the test section is at least equal to the internal diameter of the test section, it is ensured that there be no flow rate decrease from the first CO₂ vessel and towards the test section. By having a smaller diameter in the test section, the flow rate of the CO₂ may be manipulated to increase in the test section, if this is desired. The first sensor may be arranged on a part of the fluid communication channel which has a decrease in diameter in order to establish the effect of the reduction of diameter on the flow of the CO₂.

The present disclosure also relates to a method of testing the effect of a CO₂ stream on downhole equipment, the method comprising the steps of: providing a first predefined amount of CO₂ in a first CO₂ vessel, releasing the first predefined amount of CO₂ from the first CO₂ vessel, creating a CO₂ stream into a test section holding downhole equipment, the CO₂ stream passing the downhole equipment, providing a first sensor output at an upstream position of the downhole equipment, providing a second sensor output at a downstream position of the downhole equipment, and collecting the first predefined amount of CO₂ in a second CO₂ vessel.

The following is an explanation of exemplary embodiments with reference to the drawings in which:

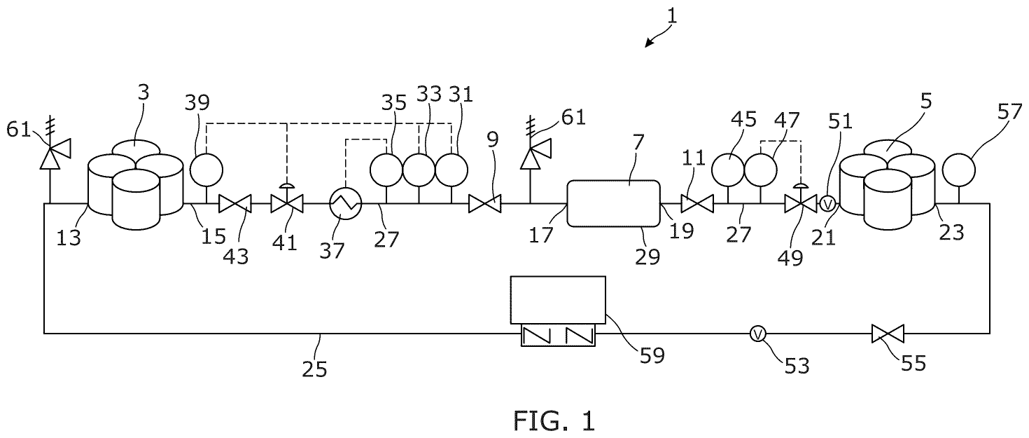

FIG. 1 is a schematic drawing of an embodiment test system in accordance with the present disclosure,

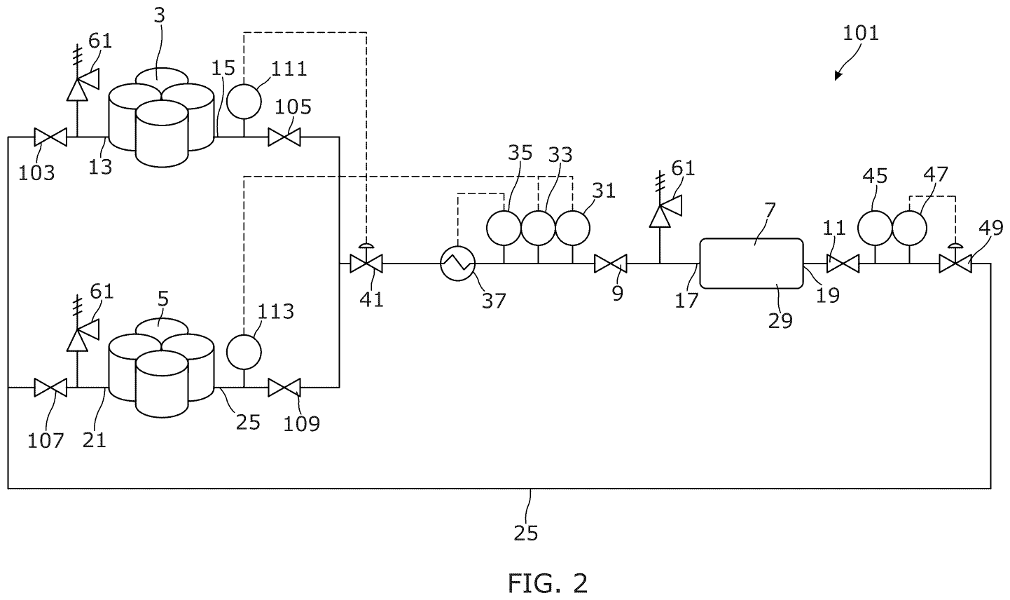

FIG. 2 is a schematic drawing of an embodiment of a test system in accordance with the present disclosure,

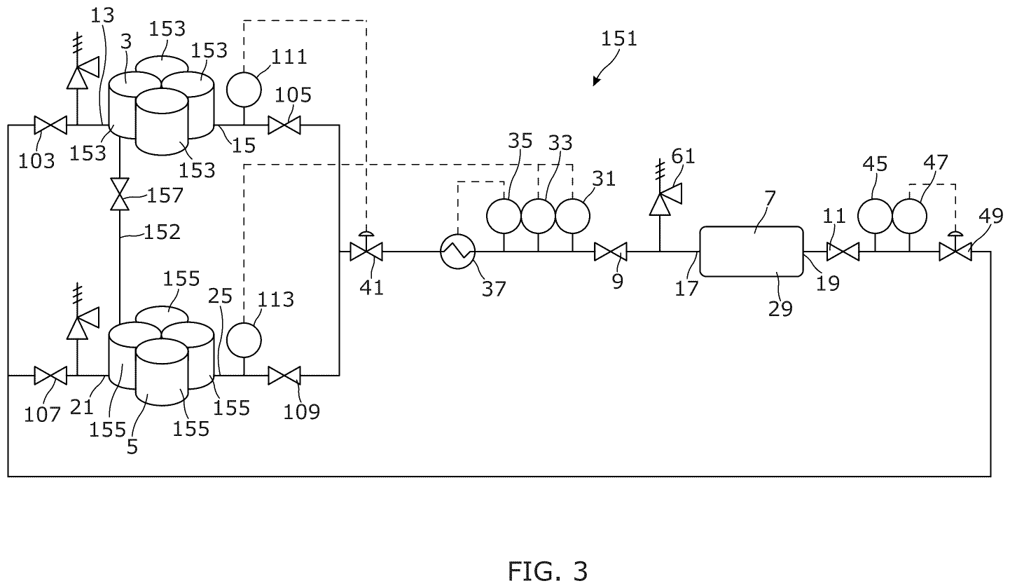

FIG. 3 is a schematic drawing of an embodiment of a test system in accordance with the present disclosure, and

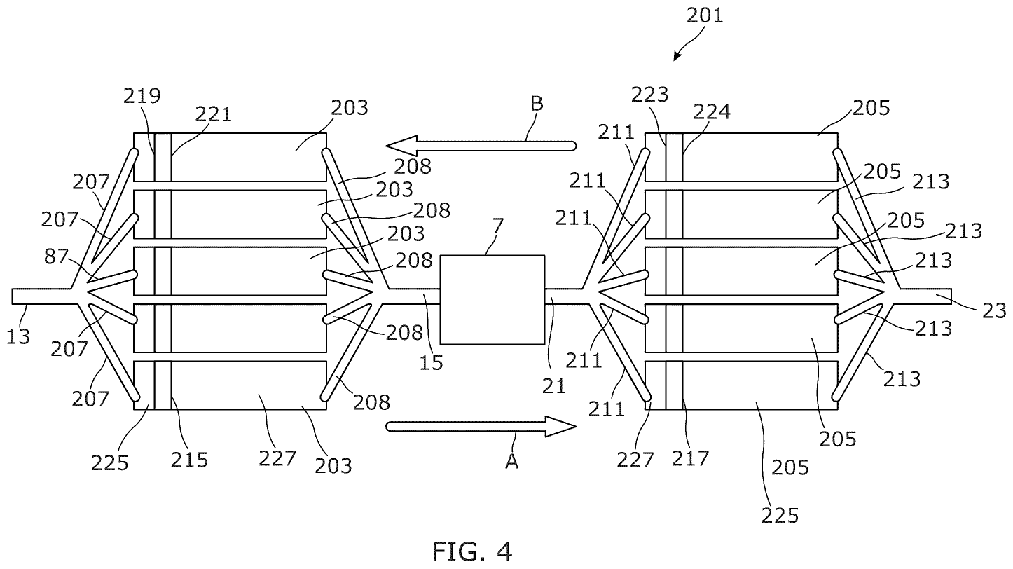

FIG. 4 is a schematic drawing of a first CO₂ vessel and a second CO₂ vessel in fluid communication with a test section.

Various exemplary embodiments and details are described below, with reference to the figures when relevant. It should be noted that the figures may or may not be drawn to scale and that elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure. In addition, an illustrated embodiment needs not have all the aspects or advantages shown. An aspect or an advantage described in conjunction with a particular embodiment is not necessarily limited to that embodiment and can be practised in any other embodiments even if not so illustrated, or if not so explicitly described.

FIG. 1 shows a schematic view of a test system 1 in accordance with the present disclosure, where the test system 1 comprises a first CO₂ vessel 3, a second CO₂ vessel 5, a test section 7 as well as a first valve 9 and a second valve 11. The system shown in FIG. 1 also has a recirculation loop 25 which allows the CO₂ to be recirculated in a circular flow along the test system 1. The first CO₂ vessel 3 comprises a first CO₂ input 13 and a first CO₂ output 15, and the second CO₂ vessel 5 comprises a second CO₂ input 21 and a second CO₂ output 23. The first CO₂ input 13 and the second CO₂ output 23 may be seen as optional, as the test system shown in FIG. 1 may be provided without a recirculation loop 25, where the direction of flow of CO₂ may be reversed, or the CO₂ collected in the second CO₂ vessel may be pumped back towards the first tank through the test section 7 in order to recharge the first CO₂ vessel with the CO₂ to perform a test.

The test system 1 may be operated by providing a first amount of CO₂ inside the first CO₂ vessel 3, where the first valve 9 prevents the CO₂ from travelling downstream towards the test section 7. The first valve 9 may be in fluid communication with the first CO₂ output 15, and when the first valve 9 is opened, the CO₂ flows along a fluid communication conduit 27 from the first CO₂ output 15 and past the open first valve 9 and into a third CO₂ input 17 of the test section 7. The test section 7 may be a chamber 29 holding downhole equipment inside a chamber 29, where the chamber is in fluid communication with the third CO₂ input 17 and with a third CO₂ output 19. When the CO₂ flows into the third CO₂ input 17, it enters the chamber 29 and passes the downhole equipment, such as a downhole valve or similar downhole equipment, and flows towards the third CO₂ output 19, where the CO₂ passes the second valve 11, which is in an open state, and through a fluid communication conduit 27 into the second CO₂ input 21 of the second CO₂ vessel. The second CO₂ vessel 5 may be configured to collect all the CO₂ that is sent through the test section 7 from the first CO₂ vessel 3 in order to collect and hold the used CO₂ and to ensure that the CO₂ does not escape the test system 1 after testing has been performed. Thus, the test system 1 may be a closed test system where the CO₂ may be reused for subsequent testing, and the valves may be utilised to ensure that the CO₂ present in the CO₂ vessels does not escape when the chamber 29 of the test section 7 is opened to replace the downhole equipment to be tested.

The test system 1 also comprises the recirculation loop 25, where the recirculation loop provides fluid communication between the second CO₂ output 23 of the second CO₂ vessel 5 and the first CO₂ input 13 of the first CO₂ vessel 3. This means that when the CO₂ has been collected in the second CO₂ vessel 5 after a test has been performed, the CO₂ may be transferred via the recirculation loop 25 back to the first CO₂ vessel 3 in order to recharge the first CO₂ vessel 3 for a subsequent test.

The test system 1 may further comprise a first pressure sensor 31, a first temperature sensor 33, a first flow sensor 35 which are arranged on the flow conduit 27 between the first CO₂ output 15 and the third CO₂ input 17 of the test section 7. The first sensors 31, 33, 35 may be utilised to measure a characteristic of the CO₂ flowing out of the first CO₂ vessel 3 prior to it entering the test section 7.

The first temperature sensor 33 may be connected to a heat exchanger 37 in a feedback loop where the measured temperature of the CO₂ may be utilized to adjust the temperature using the heat exchanger 37. The heat exchanger 37 may also be utilised together with the first pressure sensor 31 (not shown) where the pressure and temperature of the CO₂ may be used to adjust the temperature of the CO₂ in the heat exchanger for a phase change of the CO₂ travelling through the heat exchanger. Thus, as an example, a liquid CO₂ may be heated up in order to phase change the CO₂ to solid or supercritical CO₂ if the test specification requires the CO₂ to be in that form. Thus, the heat exchanger 37 may be adjusted on feedback from the first temperature sensor 33 and/or the first pressure sensor 31 to adjust the temperature of the CO₂ to a suitable temperature for the desired phase of the CO₂.

The test system 1 may further comprise a third pressure sensor 39, where the third pressure sensor 39 may be arranged upstream from the heat exchanger 37 and or a regulator valve 41. The output of the third pressure sensor 39, the first temperature sensor 33 and the first flow sensor 35 may be utilised to operate the regulator valve 41, so that the pressure before the regulator valve and the pressure after the regulator valve may e.g. be used as feed-forward or feed-back on how open the regulator valve 41 has to be in order to get the desired pressure into the test section 7, or where the first flow sensor 35 is used to obtain the desired flow into the test section 7. Thus, the first sensors 31, 33, 35 and the third sensor 39 may be utilised to adjust the characteristics of the CO₂ flow from the first CO₂ vessel 3 and into the test section 7 by operating the regulator valve 41 and/or the heat exchanger 37 to have the CO₂ obtain its required or desired flow characteristics in the test section 7 in order to test the downhole equipment in accordance with the test specifications.

The test system 1 may comprise a third valve 43 arranged prior to the regulator valve 41 which can open and close fluid communication between the regulator valve 41 and the first CO₂ output 15.

The test system may further comprise a second temperature sensor 45, a second pressure sensor 47 and a second flow sensor (not shown) which are positioned downstream of the test section 7 and upstream of the second CO₂ vessel 5. The test system 1 may further comprise a second regulator valve 49 which is downstream of the test section 7, where the measurements of the second pressure sensor 47 may be utilized to control the second regulator valve 49. Thus, the pressure measured downstream of the test section 7 may have to be adjusted in order to ensure that the CO₂ flows effectively and as desired through the test section 7, e.g. in order to ensure that the pressure upstream of the test section 7 is higher than the pressure downstream of the test section 7 to make sure that the CO₂ flows in the correct direction.

The test system 1 may further comprise a compression pump 51 in order to create a low-pressure zone upstream of the pump 51 and a high-pressure zone downstream of the pump in order to compress the CO₂ or to pump the CO₂ into the second CO₂ vessel 5.

The test system 1 may further comprise a recirculation pump 53 arranged in the recirculation loop 25 in order to ensure that the CO₂ may be pumped back to the first CO₂ vessel 3 from the second CO₂ vessel 5. The test system 1 may also comprise a fourth valve 55 which is arranged on the recirculation loop 25 in order to close the fluid communication between the second CO₂ vessel 5 and the first CO₂ vessel 3 when recirculation is not needed, e.g. when a test is being run.

The test system 1 may further comprise a fourth pressure sensor 57 which is arranged downstream of the second CO₂ output 23 of the second CO₂ vessel 5 to measure the pressure of the CO₂ in the recirculation loop 25.

The test system 1 may further comprise a gas booster 59 which is arranged downstream of the second CO₂ output 23 of the second CO₂ vessel 5 and which may be utilised to increase the pressure inside the recirculation loop 25.

The first CO₂ vessel 3 and the second CO₂ vessel 5 may be utilised as CO₂ buffers in order to ensure that the system has sufficient amounts of CO₂ to perform a test of downhole equipment.

The test system 1 shown in FIGS. 1, 2 and 3 may be provided with one or more safety valves 61 placed in different positions. The safety valves allow pressure to be released from the system in a region of the system 1 having a safety valve 61 if the pressure of the system exceeds a predefined safety limit.

FIG. 2 shows a test system 101 which has a similar function as the test system 1 shown in FIG. 1, where the reference numbers in FIG. 1 are also applicable to the reference numbers in FIG. 2, and the same elements shown in FIG. 1 may be present in the test system 101 of FIG. 2. The difference in the test system 1 may be seen where the system 1 has been rearranged by providing the first CO₂ vessel 3 and the second CO₂ vessel 5 in parallel fluid communication with the third CO₂ input and the third CO₂ output of the test section 7. The first CO₂ vessel 3 has been provided with a fifth valve 103 in fluid communication with the first CO₂ output 15 and a sixth valve 105 in fluid communication with the first CO₂ input 13, and the second CO₂ vessel 5 has been provided with a seventh valve 107 in fluid communication with the second CO₂ output 23 and an eighth valve 109 in fluid communication with the second CO₂ input 21. This parallel arrangement of the first CO₂ vessel 3 and the second CO₂ vessel 5 means that in a first test when CO₂ is arranged to flow into the test section 7, the CO₂ may flow from the first CO₂ vessel 3 via the first CO₂ output 15 and may be collected via the recirculation loop 25 by the second CO₂ vessel 5. Thus, in order to do this, the sixth valve 105 is open, while the fifth valve 103 is closed, and the seventh valve 107 is open, and the eighth valve 109 is closed. When a subsequent test is to be performed, the second CO₂ vessel 5 may be utilised to deliver the CO₂ towards the test section 7, while the first CO₂ vessel 3 may be utilised to collect the CO₂ downstream of the test section 7. Thus, for this to work, the eighth valve 109 is open, while the seventh valve 107 is closed, while the fifth valve 103 is open, and while the sixth valve 105 is closed. Thereby, the functioning of the CO₂ vessels may be inversed as necessary, and there is no need to recirculate CO₂ from one vessel to another vessel in between tests in order to recharge the test system 101.

The test system 101 may further comprise a fifth pressure sensor 111 that is arranged between the sixth valve 105 and the first CO₂ output 15, and a sixth pressure sensor 113 that is arranged between the eighth valve 109 and the second CO₂ output 23, where the output of the fifth pressure sensor 111 and the sixth pressure sensor 113 may be utilised to control the regulator valve 41, similarly to what is shown in FIG. 1.

FIG. 3 shows a test system 151 having a different arrangement than the test system 101 shown in FIG. 2, where a fluid communication channel 152 is provided between the first CO₂ vessel 3 and the second CO₂ vessel 5. In this instance, the first CO₂ vessel 3 and the second CO₂ vessel 5 comprise a plurality of first vessel sections 153 and a plurality of second vessel sections 155. Thus, the fluid communication channel 152 may be connected between one first vessel section 153 and one second vessel section 155, allowing collected CO₂ in one of the vessel sections 153, 155 to be transferred to the opposite of the vessel sections 153, 155 during the performance of a test. Thus, if more CO₂ is needed for a test, the fluid communication channel 152 may transfer CO₂ during a test between the first CO₂ vessel 3 and the second CO₂ vessel 5. The fluid communication channel 152 may be provided with a ninth valve 157 which may be used to selectively open and close the fluid communication channel 152.

FIG. 4 shows a schematic diagram of a test system 201, where the test system 201 may be similar to and have the same components as shown in the embodiments in FIG. 1, FIG. 2 and FIG. 3. This FIG. 4 intends to show the first CO₂ vessel 3 and the second CO₂ vessel 5 where the first CO₂ vessel 3 has separate first vessel sections 203, and the second CO₂ vessel has separate second vessel sections 205. Each vessel section 203 of the first CO₂ vessel 3 has a first vessel section input 207 and a first vessel section output 208, and each vessel section 205 of the second CO₂ vessel 5 has a second vessel section input 211 and a second vessel section output 213. The first vessel section inputs 207 may be connected with the first CO₂ input 13, and the second vessel section outputs 213 may be connected with the first CO₂ output 15. The second vessel section inputs 211 may be connected with the second CO₂ input 21, and the second vessel section outputs 213 may be connected with the second CO₂ output 23.

Each first vessel section 203 of the first CO₂ vessel 3 may be provided with a first piston 215, and each second vessel section 205 of the second CO₂ vessel 5 may be provided with a second piston 217. The first piston 215 may have a primary side 219 and a secondary side 221, and the second piston 217 may have a primary side 223 and a secondary side 224. The part of the vessel section 203 facing the primary side 219 of the first piston 215 may hold an incompressible fluid 225 and on the opposite secondary side may hold CO₂ 227. The part of the vessel section 205 facing the primary side 223 of the first piston 215 may hold CO₂ and on the opposite secondary side may hold an incompressible fluid 225.

When a test is to be performed in a direction A, the incompressible fluid 225 may be pumped into the first CO₂ vessel 3 using the first input 13, which means that the first piston 215 moves in a direction towards the test section 7 and forces the CO₂ into the test section 7. In the second CO₂ vessel 5, the second piston 217 may move in a direction away from the test section 7 to increase the volume of the second vessel section 205 to receive the CO₂ from the test section 7. This may cause the part of the second vessel 5 to reduce and the incompressible fluid 225 to be pushed out of the second output 23, or a pump may pump the incompressible fluid 225 from the secondary side to pull the fluid out of the second vessel section 205.

This allows the CO₂ to be forced through the test section 7 at a high rate. When a subsequent test is to be performed, the process may be reversed, and the test may be performed in a direction B, where the incompressible fluid 225 is pumped into the second vessel section 205 and pushes the CO₂ 227 from the second vessel section 205 into the test section 7.

The use of the terms “first”, “second”, “third” and “fourth”, “primary”, “secondary”, “tertiary”, etc., does not imply any particular order, but the terms are included to identify individual elements. Moreover, the use of the terms “first”, “second”, “third” and “fourth”, “primary”, “secondary”, “tertiary”, etc., does not denote any order or importance, but rather the terms “first”, “second”, “third” and “fourth”, “primary”, “secondary”, “tertiary”, etc., are used to distinguish one element from another. Note that the words “first”, “second”, “third” and “fourth”, “primary”, “secondary”, “tertiary”, etc., are used here and elsewhere for labelling purposes only and are not intended to denote any specific spatial or temporal ordering.

Furthermore, the labelling of a first element does not imply the presence of a second element and vice versa.

It is to be noted that the word “comprising” does not necessarily exclude the presence of other elements or steps than those listed.

It is also to be noted that the words “a” or “an” preceding an element do not exclude the presence of a plurality of such elements.

It should further be noted that any reference signs do not limit the scope of the claims. Although features have been shown and described, it will be understood that they are not intended to limit the claimed invention, and it will be made obvious to those skilled in the art that various changes and modifications may be made without departing from the spirit and scope of the claimed invention. The specification and drawings are, accordingly, to be regarded in an illustrative rather than restrictive sense. The claimed invention is intended to cover all alternatives, modifications, and equivalents.

1. A test system comprising:
a first CO₂ vessel having a first predefined volume configured to hold and/or receive a first predefined amount of CO₂, having a first CO₂ output,
a second CO₂ vessel having a second predefined holding volume configured to hold and/or receive a second predefined amount of CO₂ having a second CO₂ input,
a test section having a third CO₂ input in fluid communication with the first CO₂ output and a third CO₂ output in fluid communication with the second CO₂ input, where the test section is configured to hold a first sample,
a first valve arranged between the first CO₂ output and the third CO₂ input, and
a second valve arranged between the third CO₂ output and the second CO₂ input.

2. A test system in accordance with claim 1, wherein the test system comprises at least one first sensor chosen from a list of a first pressure sensor, a first temperature sensor and a first flow sensor, where the sensor is positioned in fluid communication with the first CO₂ output, and optionally with the third CO₂ input.

3. A test system in accordance with claim 1, wherein the test system comprises at least one second sensor chosen from a list of a second pressure sensor, a second temperature sensor and a second flow sensor, where the sensor is positioned in fluid communication with the second CO₂ input, and optionally with the third CO₂ output.

4. A test system in accordance with claim 1, wherein the test system comprises a third valve arranged between the second CO₂ input and the third CO₂ output and controlled by the second pressure sensor.

5. A test system in accordance with claim 1, wherein the test system comprises a recirculation loop providing fluid communication between a first CO₂ input of the first CO₂ vessel and a second CO₂ output of the second CO₂ vessel.

6. A test system in accordance with claim 1, wherein the third output of the test section is in selective fluid communication with the first CO₂ input of the first CO₂ vessel and/or the second CO₂ input of the second CO₂ vessel.

7. A test system in accordance with claim 1, wherein the test system comprises a heat exchanger arranged between the first CO₂ output and the third CO₂ input.

8. A test system in accordance with claim 1, wherein the test system comprises a regulator valve positioned between the first CO₂ output and the third CO₂ input.

9. A test system in accordance with claim 1, wherein the first CO₂ vessel is configured to have a first pressure, and the second CO₂ vessel is configured to have a second pressure, where the first pressure is greater than the second pressure, or the second pressure is greater than the first pressure.

10. A test system in accordance with claim 1, wherein the first CO₂ vessel and/or the second CO₂ vessel comprises a plurality of vessel sections, each having a first predefined volume, where a plurality of vessel sections define the first predefined CO₂ amount and/or the second predefined CO₂ amount.

11. A test system in accordance with claim 1, wherein each vessel section comprises a vessel section input and a vessel section output, where the vessel section inputs are in fluid communication with the first CO₂ input and/or the second CO₂ input, and where the vessel section outputs are in fluid communication with the first CO₂ output and/or the second CO₂ output.

12. A test system in accordance with claim 1, wherein each vessel section comprises a piston, where one side of the piston is configured to hold an incompressible fluid, and the opposing side of the piston is configured to hold CO₂.

13. A test system in accordance with claim 1, wherein the first output has a first internal diameter, and the test section has a third internal diameter, where the first internal diameter is larger than or equal to the third internal diameter.

14. A method of testing the effect of a CO₂ stream on downhole equipment, the method comprising the steps of:
providing a first predefined amount of CO₂ in a first CO₂ vessel,
releasing the first predefined amount of CO₂ from the first CO₂ vessel,
creating a CO₂ stream into a test section holding downhole equipment, the CO₂ stream passing the downhole equipment,
providing a first sensor output at an upstream position of the downhole equipment,
providing a second sensor output at a downstream position of the downhole equipment, and
collecting the first predefined amount of CO₂ in a second CO₂ vessel.
